(19) United States
(12) Patent Application Publication
(10) Pub. No.: US 2018/0207046 A1
(43) Pub. Date: Jul. 26, 2018

(54) Limb Moving Assembly

(71) Applicant: Donna Doncaster, Innisfil (CA)

(72) Inventor: Donna Doncaster, Innisfil (CA)

(21) Appl. No.: 15/412,613

(22) Filed: Jan. 23, 2017

(51) Int. Cl. A61H 1/02; A61H 1/00

(52) U.S. Cl. CPC A61H 1/0237; A61H 2205/10; A61H 2201/164; A61H 1/008

(57) ABSTRACT

A limb moving assembly facilitates movement of a limb which is otherwise inhibited from free movement without assistance. The assembly includes a strap to be looped beneath a foot of a user. The strap facilitates a leg of the user to be moved when the leg has been injured or is otherwise immobile. A pad is coupled to the strap. The foot is selectively positioned on the pad.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to moving devices and more particularly pertains to a new moving device for engaging and moving an injured or otherwise immobile limb.

### BRIEF SUMMARY OF THE INVENTION

An embodiment of the disclosure meets the needs presented above by generally comprising a strap that may be looped beneath a foot of a user. In this way the strap facilitates a leg of the user to be moved when the leg has been injured or is otherwise immobile. A pad is coupled to the strap. The foot is selectively positioned on the pad.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a limb moving assembly according to an embodiment of the disclosure.

FIG. 2 is a perspective in-use view of an embodiment of the disclosure.

FIG. 3 is a top view of an embodiment of the disclosure.

FIG. 4 is a cross sectional view taken along line 4-4 of FIG. 3 of an embodiment of the disclosure.

### DETAILED DESCRIPTION OF THE INVENTION

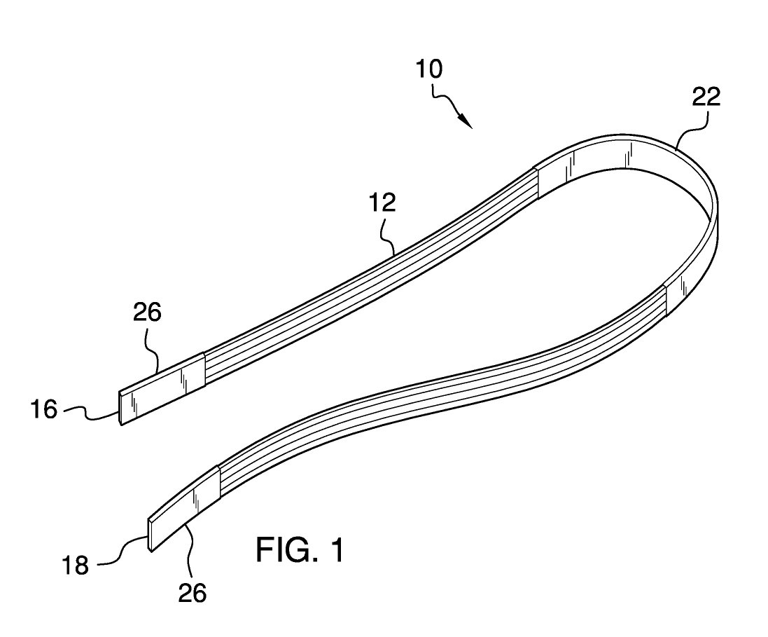

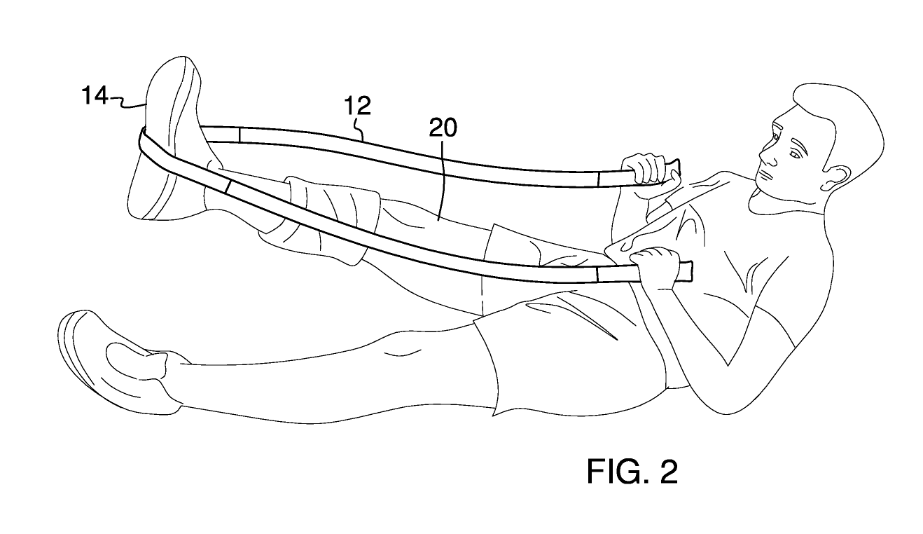

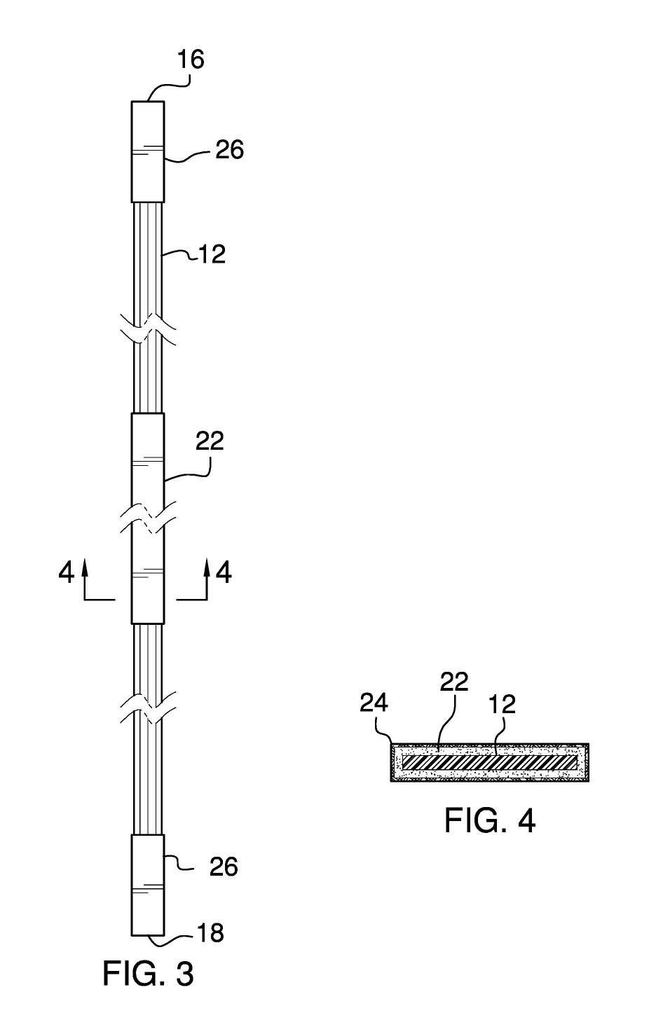

With reference now to the drawings, and in particular to FIGS. 1 through 4 thereof, a new moving device embodying the principles and concepts of an embodiment of the disclosure and generally designated by the reference numeral 10 will be described.

As best illustrated in FIGS. 1 through 4, the limb moving assembly 10 generally comprises a strap 12 that may be looped beneath a foot 14 of a user. The strap 12 has a first end 16 and a second end 18 and each of the first end 16 and the second end 18 may be gripped. Thus, a leg 20 of the user may be moved when the leg 20 has been injured or is otherwise immobile. The strap 12 may have a length ranging between approximately 1.5 meters and 2.0 meters. The user may be an injured person, a physical disabled person or any other person that has limited use of their legs.

A pad 22 is provided and the pad 22 is coupled to the strap 12. The user's foot 14 is positioned on the pad 22 when the strap 12 is looped beneath the user's foot 14. The pad 22 may be comprised of a resiliently compressible material such as foam rubber or the like. Thus, the pad 22 frictionally engages the user's foot 14 to inhibit the user's foot from slipping off the strap 12 when the user's leg is moved. A cover 24 may be provided and the cover 24 may be wrapped around the pad 22. The cover 24 may be comprised of a fluid impermeable material or the like. The strap 12 extends through the pad 22 and the pad 22 is centrally positioned between the first end 16 and the second end 18. Moreover, the pad 22 is elongated along an axis extending through the first end 16 and the second end 18.

A pair of grips 26 is provided. Each of the grips 26 is coupled to the strap 12 and each of the grips 26 may be gripped. Each of the grips 26 is positioned on an associated one of the first end 16 and the second end 18. Additionally, each of the grips 26 may comprise a rectangular pad or the like and each of the grips 26 may be comprised of a resiliently compressible material.

In use, the strap 12 is looped beneath the user's foot 14 having the user's foot 14 being positioned on the pad 22. Each of the grips 26 is gripped and the strap 12 is manipulated to lift the user's foot 14 when the user's leg 20 has been injured or is otherwise immobile. In this way the user may move the user's leg 20 without assistance from a caregiver or the like. Thus, the user may position the user's leg 20 on a footrest in a wheelchair, a physical therapy device or any other object that can support the user's leg 20. Additionally, the strap 12 may be manipulated to move the leg 20 through a series of motions corresponding to physical rehabilitation. In this way the strap 12 facilitates an injury to be rehabilitated.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A limb moving assembly being configured to assist moving an injured or otherwise immobile limb, said assembly comprising:
a strap being configured to be looped beneath a foot of a user thereby facilitating a leg of the user to be moved when the leg has been injured or is otherwise immobile; and
a pad being coupled to said strap wherein said pad is configured to have the foot positioned thereon.

2. The assembly according to claim 1, wherein said strap has a first end and a second end, each of said first end and said second end being configured to be gripped.

3. The assembly according to claim 2, further comprising said strap extending through said pad, said pad being centrally positioned between said first end and said second end, said pad being elongated along an axis extending through said first end and said second end.

4. The assembly according to claim 2, further comprising a pair of grips, each of said grips being coupled to said strap wherein each of said grips is configured to be gripped, each of said grips being positioned on an associated one of said first end and said second end.

5. A limb moving assembly being configured to assist moving an injured or otherwise immobile limb, said assembly comprising:
a strap being configured to be looped beneath a foot of a user, said strap having a first end and a second end, each of said first end and said second end being configured to be gripped thereby facilitating a leg of the user to be moved when the leg has been injured or is otherwise immobile;
a pad being coupled to said strap wherein said pad is configured to have the foot positioned thereon, said strap extending through said pad, said pad being centrally positioned between said first end and said second end, said pad being elongated along an axis extending through said first end and said second end; and
a pair of grips, each of said grips being coupled to said strap wherein each of said grips is configured to be gripped, each of said grips being positioned on an associated one of said first end and said second end.
